(19) United States
(12) Patent Application Publication
(10) Pub. No.: US 2015/0070724 A1
(43) Pub. Date: Mar. 12, 2015

(54) INFORMATION PROCESSING SYSTEM AND INFORMATION PROCESSING METHOD

(71) Applicant: Hiroshi KAMIMOTO, Kanagawa (JP)

(72) Inventor: Hiroshi KAMIMOTO, Kanagawa (JP)

(73) Assignee: RICOH COMPANY, LIMITED, Tokyo (JP)

(21) Appl. No.: 14/475,621

(22) Filed: Sep. 3, 2014

(30) Foreign Application Priority Data
Sep. 12, 2013 (JP) 2013-189898

(51) Int. Cl. G06F 3/12; H04N 1/00; G06F 9/48

(52) U.S. Cl. CPC G06F 3/1275; G06F 3/1288; G06F 9/4843; H04N 1/00225; H04N 1/00233; H04N 1/00244; H04N 1/00949; H04N 2201/0094
USPC 358/1.15

(57) ABSTRACT

An information processing system includes an information processing apparatus including a first computer program and one or more electronic apparatuses including a second computer program. The first computer program includes an addition unit that receives additional setting information on a function executed in the one or more electronic apparatuses and not executed by the second computer program, and a first communication unit that transmits one or more pieces of setting information including the additional setting information to the second computer program included in the one or more electronic apparatuses. The second computer program including a second communication unit that receives the setting information transmitted from the information processing apparatus, and an output unit that selectively outputs the received setting information.

### CROSS-REFERENCE TO RELATED APPLICATIONS

The present application claims priority to and incorporates by reference the entire contents of Japanese Patent Application No. 2013-189898 filed in Japan on Sep. 12, 2013.

### BACKGROUND OF THE INVENTION

1. Field of the Invention

The present invention relates to an information processing system and an information processing method.

2. Description of the Related Art

Document distribution systems are known that distribute various types of input images such as scanned images, captured images, and printed images. A document distribution system, for example, includes an application (management tool) installed on an information processing apparatus such as a personal computer (PC) and an application (apparatus application) installed on an electronic apparatus operating in accordance with settings set by the management tool. In order to implement a case in which a user distributes an input image after converting it into portable document format (PDF) with text by optical character recognition (OCR) processing in the document distribution system described above, a conventional method has been developed in which an administrator sets OCR languages in the management tool and distributes the setting on the OCR languages to the apparatus application, so that the OCR languages are presented to the user when the user scans a document.

Japanese Patent Application Laid-open No. 2010-166174 describes a document distribution system that presents a list of setting items of plug-ins available for a workflow in order to enhance usability for users in setting the workflow.

When an electronic apparatus having a new function is provided and an application installed on the electronic apparatus does not have a setting corresponding to the new function, the conventional method cannot properly present to a user setting information corresponding to the new function because the application is not configured to process the new function that is not installed on the previous model of the electronic apparatus.

Therefore, it is desirable to provide an information processing system and an information processing method that can properly output setting information corresponding to functions when an electronic apparatus having a new function is provided.

### SUMMARY OF THE INVENTION

It is an object of the present invention to at least partially solve the problems in the conventional technology.

According to an aspect of the present invention, there is provided an information processing system including: an information processing apparatus including a first computer program; and one or more electronic apparatuses including a second computer program, the first computer program including an addition unit that receives additional setting information on a function executed in the one or more electronic apparatuses and not executed by the second computer program, and a first communication unit that transmits one or more pieces of setting information including the additional setting information to the second computer program included in the one or more electronic apparatuses; the second computer program including a second communication unit that receives the setting information transmitted from the information processing apparatus, and an output unit that selectively outputs the received setting information.

According to another aspect of the present invention, there is provided an information processing method performed by an information processing system including an information processing apparatus including a first computer program and one or more electronic apparatuses including a second computer program, the information processing method including: receiving, by the first computer program, additional setting information on a function executed in the one or more electronic apparatuses and not executed by the second computer program, transmitting, by the first computer program, one or more pieces of setting information including the additional setting information to the second computer program included in the one or more electronic apparatuses; receiving, by the second computer program, the setting information transmitted from the information processing apparatus, and outputting selectively, by the second computer program, the received setting information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration example of an information processing system according to an embodiment;

FIG. 2 is a diagram illustrating a configuration example of hardware and software of a multifunction peripheral (MFP);

FIG. 3 is a block diagram illustrating an example of a functional configuration of the information processing system according to the embodiment;

FIG. 4 is a sequence diagram illustrating an example of setting information transmission processing in the embodiment;

FIG. 5 is a sequence diagram illustrating an example of scanning processing in the embodiment;

FIG. 6 is a block diagram illustrating a hardware configuration of the MFP according to the embodiment; and

FIG. 7 is a diagram illustrating a hardware configuration of an information processing apparatus according to the embodiment.

### DETAILED DESCRIPTION OF THE PREFERRED EMBODIMENT

The following describes in detail an embodiment of an information processing system, an information processing method and a computer program according to the present invention with reference to the accompanying drawings.

The following describes an information processing system to which the present invention is applied and that includes one or more electronic apparatuses having at least the OCR function and an information processing apparatus on which an application (management tool) for setting the OCR function operates. The system to which the present invention is applicable is not limited to the information processing system described above. The function that the one or more electronic apparatuses have is not limited to the OCR function.

Some electronic apparatuses can add or update functions by adding or updating software after product shipment, for example. Examples of the software to be added or updated include printing application software and workflow application software. The printing application software associates print data received from a client such as a PC with authentication information on a user and stores the resulting print data. When the user wants to print the data, the printing application software requires the user to perform an authentication process so that only an authenticated user can print the data. The workflow application software performs data processing determined by a workflow set in advance on target data to be processed such as image data acquired by scanning or image-capturing or image data (document data) created by using a document preparation application. The workflow application software then delivers (transmits) the image data to an external device (such as a mail server or an FTP server) via a network.

These types of software can extend their functions by adding a new function or updating the existing function. For example, the workflow application software extends data processing functions constituting a workflow. The administrator uses the management tool to specify one or more processes in order from processes of executable data processing to define a workflow. The administrator stores workflow definition information defined on the electronic apparatus in a certain storage area. The user uses a display screen of the electronic apparatus to select a desired workflow from defined workflows. The user sets bibliographic information on the target data to be processed and conditions on the processes, and selects execution. This causes the electronic apparatus to perform data processing on the basis of the selected workflow and the settings in accordance with the execution request received from the user.

Examples of the data processing (functions) described above include data conversion processing, OCR processing, overlay processing, code reading processing, delivery processing, approval processing, and translation processing. The data processing is not limited to these examples. The workflow application software may include other types of processing suitable for user's usage or satisfying user's requirements.

With regard to functions provided for an electronic apparatus in advance (at a time of product shipment), it is common for a new model of the electronic apparatus to include an additional new function that was not provided for the conventional models. For example, there may be a case in which a newer version of the electronic apparatus has the OCR function but the previous version thereof does not. There may also be a case in which a new version of the electronic apparatus having the OCR function supports Japanese, English, Spanish, and Mandarin, but the previous version thereof only supports Japanese and English.

In such cases, the conventional workflow application software (apparatus application) can only create a workflow with processes that can be executed by a combination of data processing supported by the apparatus application and data processing (such as scanning processing) supported by the conventional electronic apparatus as a standard function.

When, for example, the OCR function included in the apparatus application only supports Japanese as an OCR function language, and when a user wants to execute workflow processing using the apparatus application, the user can only select Japanese as the OCR function language in the workflow processing even though the electronic apparatus supports other languages (such as English) for the OCR function.

When the user wants to use the OCR function in English and execute a workflow, the user is required to select the OCR function from functions supported by the electronic apparatus as standard functions through a display screen. The user is required to execute the OCR function in English on target data to be processed, and to perform a selection operation to cause the apparatus application to execute the workflow with the processed data obtained by executing the OCR function (or, with an output document when the user prints out the document after the OCR processing).

The information processing system according to the present embodiment enables the electronic apparatus to properly output (present) setting information so that a user can execute, by using the apparatus application, a setting corresponding to a function added to the electronic apparatus as a standard function without performing such a complicated procedure. Specifically, the information processing system according to the present embodiment can register additional setting information (an OCR language ID), and output the additional OCR language ID so that the administrator or a user can select it. This enables the user to select and use the new setting information (the OCR language ID) corresponding to a function added to the electronic apparatus.

When each electronic apparatus supports different OCR languages (standard functions) available to users, information is open to at least a part of the users (such as the administrator and support personnel) as to what kind of setting information (OCR language ID) needs to be specified at the time of scanning to execute the OCR processing in each of the OCR languages. The information can be acquired as appropriate. In other words, setting information for using a standard function supported by an electronic apparatus can be interpreted by at least the administrator or support personnel.

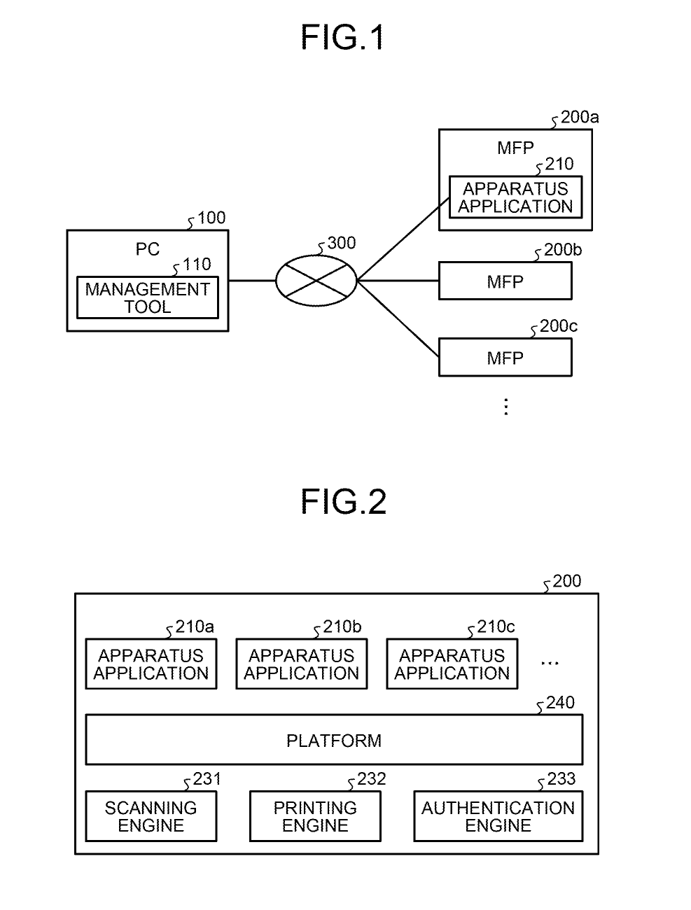

FIG. 1 is a block diagram illustrating a configuration example of the information processing system according to the present embodiment. As illustrated in FIG. 1, the information processing system has a configuration in which a PC 100 as an information processing apparatus is connected to MFPs 200a to 200c as electronic apparatuses via a network 300.

The network 300 may be implemented by any form of networks such as the Internet or a local area network (LAN). The network 300 may be a wired network or a wireless network.

The MFPs 200a to 200c are image forming apparatuses having one or more functions from functions such as a copier function, a printer function, a scanner function (OCR function), and a facsimile function. The MFPs 200a to 200c are examples of electronic apparatuses that can perform one or more types of data processing on target data to be processed. Because the MFPs 200a to 200c have the same configuration, the MEPs 200a to 200c are simply referred to as an MFP 200 as long as they need not be distinguished from each other. The MEP 200 includes an apparatus application 210. The apparatus application 210 is an application for, for example, controlling functions supported by the MFP 200.

The PC 100 includes a management tool 110. The management tool 110 has a function of setting and managing information necessary for the operation of the MFP 200. The management tool 110 is implemented as an application (software) installed on the PC 100 to be used, and sets settings on or managing a specific apparatus application 210 (an apparatus application according to the present invention).

FIG. 2 is a diagram illustrating a configuration example of hardware and software of the MEP 200. As illustrated in FIG. 2, the MFP 200 includes a scanning engine 231, a printing engine 232, and an authentication engine 233 as main hardware resources. These hardware resources are illustrative, and the MEP 200 may include other hardware resources.

The MEP 200 includes a platform 240 and apparatus applications 210a to 210c as a main software configuration.

The platform 240 provides a function for using the hardware resources (standard functions) such as the scanning engine 231, the printing engine 232, and the authentication engine 233. The platform 240 includes, for example, an operating system and a control service that operates on the operating system. The control service interprets processing requests from the apparatus applications 210a to 210c to generate a request for acquiring a hardware resource. The platform 240 includes application program interfaces (APIs) through which the platform 240 can receive processing requests from the apparatus applications 210a to 210c.

The apparatus applications 210a to 210c are applications (hereinafter referred to as extended applications) that are newly created or whose functions are extended by using the APIs provided by the platform 240. The apparatus applications 210a to 210c are simply referred to as an apparatus application 210 as long as they need not be distinguished from each other.

Examples of the apparatus application 210 include applications (hereinafter referred to as standard applications) that have already been installed on the electronic apparatus since the electronic apparatus is introduced to the information processing system in addition to the applications newly added or extended after the introduction of the electronic apparatus. Examples of the standard applications include a scanner application for performing scanning processing (or, scanning processing and OCR processing) by using an API that controls the scanning engine 231, and a copier application for performing scanning processing and printing processing of scanned image data by using the API that controls the scanning engine 231 and an API that controls the printing engine 232.

Examples of the extended application include a workflow control application that performs scanning processing (or, scanning processing and OCR processing) by using the API controlling the scanning engine 231 and performs data processing by using a function (a function that can be added or extended) supported by an extended application to execute a workflow. The apparatus application 210 according to the present invention serves as an extended application, and an apparatus application serving as an extended application is hereinafter referred to as the apparatus application 210 unless otherwise specified.

As described above, the MFP 200 having a configuration described above receives an additional function or an updated function for a hardware resource (such as the scanning engine 231) in some cases. Normally, when a new function for a hardware resource is added, the apparatus application 210 needs to be modified. Even when the apparatus application 210 need not be modified, the MFP 200 needs to inform, for example, a user of the fact that a new function is added, or output setting information corresponding to the added function so that the user can use the function.

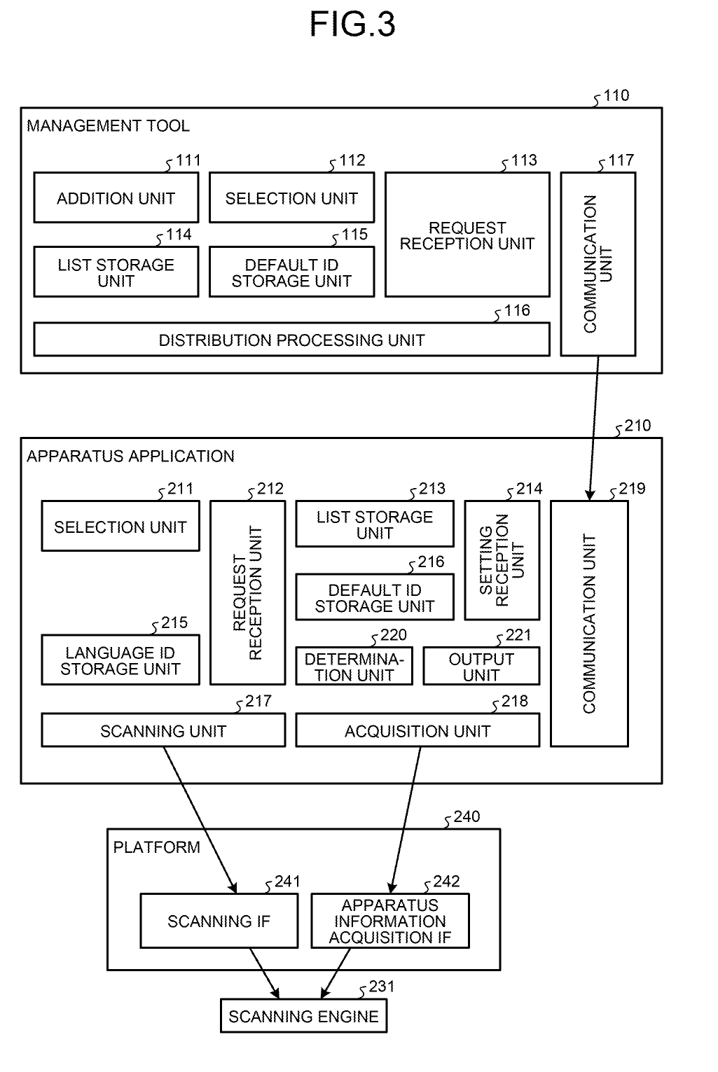

FIG. 3 is a block diagram illustrating an example of a functional configuration of the information processing system according to the present embodiment. FIG. 3 illustrates parts mainly relating to the OCR function from the parts illustrated in FIGS. 1 and 2.

The management tool 110 includes an addition unit 111, a selection unit 112, a request reception unit 113, a list storage unit 114, a default ID storage unit 115, a distribution processing unit 116, and a communication unit 117.

The addition unit 111 receives additional setting information for a function executed by the MFP 200. The present embodiment describes a case in which a new recognizable OCR language is added to the OCR function, for example. The addition unit 111, for example, receives setting information on an OCR language input by a user through a setting screen displayed on, for example, a display unit (not illustrated) of the PC 100. The setting information on the OCR language includes, for example, an OCR language ID and a name of the OCR language (an OCR language display name).

The setting information is not limited to OCR languages, and the user may set other setting information. For example, the user may set a document size, a file format, and resolution as setting information when scanning a document.

Moreover, how to input setting information is not limited to the way described above, and any method may be used as long as it can specify the setting information. For example, when an apparatuses list table is available that associates, for example, a name of an apparatus with an address and available OCR languages, the addition unit 111 may receive an input from a user for selecting an apparatus from the apparatuses list table.

The list storage unit 114 stores a list of setting information. Setting information added by the addition unit 111 is additionally registered in the list storage unit 114. In other words, the list storage unit 114 stores therein additional setting information together with the setting information already registered. When the apparatuses list table described above is used, all the OCR languages included in the apparatuses list table are stored in the list storage unit 114, for example.

The request reception unit 113 receives an operating request from a user (administrator) of the management tool 110. For example, the request reception unit 113 receives a list presentation request of OCR languages from the administrator. The request reception unit 113 receives a distribution request of setting information from the administrator.

The selection unit 112 selects an OCR language specified by the administrator as a default OCR language. For example, the selection unit 112 selects, as the default OCR language, an OCR language specified by the administrator from a list of OCR languages displayed on, for example, the display unit in accordance with the list presentation request.

The default ID storage unit 115 stores therein an OCR language ID (a default OCR language ID) of the selected default OCR language.

The distribution processing unit 116 distributes setting information (such as a list of OCR languages) and the default OCR language ID to a specified apparatus application 210 via the communication unit 117 and the network when, for example, the administrator inputs a distribution request of setting information.

The communication unit 117 is an interface through which the management tool 110 communicates with external devices such as the MFP 200. The communication unit 117, for example, transmits a list of OCR languages to the apparatus application 210 of the MFP 200 in accordance with an instruction from the distribution processing unit 116.

The apparatus application 210 includes a selection unit 211, a request reception unit 212, a list storage unit 213, a setting reception unit 214, a language ID storage unit 215, a default ID storage unit 216, a scanning unit 217, an acquisition unit 218, a communication unit 219, a determination unit 220, and an output unit 221.

The communication unit 219 is an interface through which the apparatus application 210 communicates with external devices such as the PC 100. The communication unit 219, for example, receives setting information (the OCR languages list and the default OCR language ID) transmitted from the management tool 110 of the PC 100.

The setting reception unit 214 receives the setting information transmitted from the management tool 110 via the communication unit 219.

The list storage unit 213 stores therein a list of setting information. The list storage unit 213 stores, for example, setting information received by the setting reception unit 214. The default ID storage unit 216 stores therein the default OCR language ID distributed from the PC 100.

The request reception unit 212 receives an operating request from a user of the apparatus application 210. For example, the request reception unit 212 receives a list presentation request of OCR languages from the user. The request reception unit 212 receives a request for executing scanning (scanning request) from the user.

When the apparatus application 210 receives a request for presenting a list of OCR languages from a user, the apparatus application 210 can acquire (read) a list of OCR languages and the default OCR language by referring to, for example, the list storage unit 213 and the default ID storage unit 216. These pieces of information, however, are setting information set in common among MFPs 200 by the management tool 110. Thus, the setting information needs to be determined whether it is available for each of the MFPs 200 on which the apparatus application 210 is executed. The acquisition unit 218 and the determination unit 220 provide a function for the determination processing.

The acquisition unit 218 acquires setting information that can be set on functions included in the MFP 200. The acquisition unit 218 acquires setting information via, for example, an apparatus information acquisition interface (IF) 242 that is an example of the APIs on the platform 240. The apparatus information acquisition IF 242 is an interface through which setting information that can be set on the scanning engine 231 is returned to the acquisition unit 218.

The determination unit 220 determines whether the setting information (such as an OCR languages list) received from the management tool 110 is contained in the setting information acquired by the acquisition unit 218.

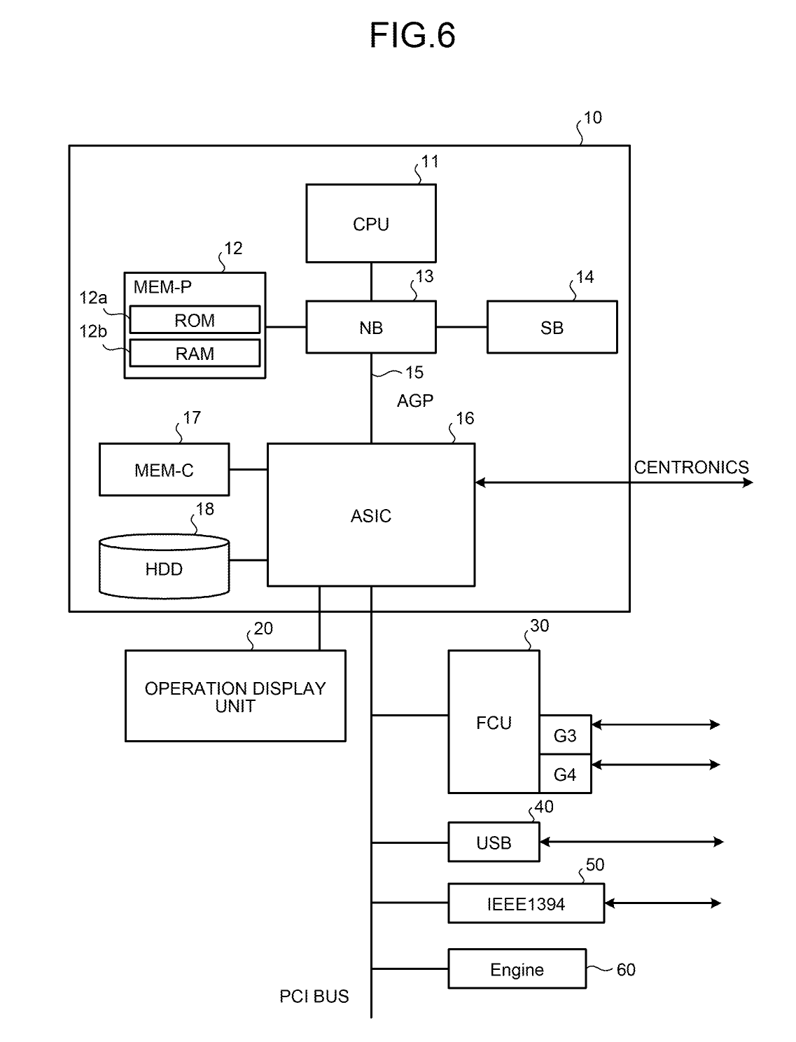

The output unit 221 outputs various types of information to the user. For example, the output unit 221 selectively outputs (displays) setting information on a display unit (such as an operation display unit 20 in FIG. 6) of the MFP 200. The output unit 221 may output setting information that is determined, by the determination unit 220, to be contained in the setting information acquired by the acquisition unit 218 from the setting information received from the management tool 110.

The selection unit 211 selects an OCR language specified by the user as an OCR language (final OCR language) that will be actually used in the OCR function. The selection unit 211 selects, as the final OCR language, the OCR language specified by the user from a list of OCR languages displayed on, for example, the display unit of the MFP 200 in accordance with a list presentation request, for example.

The language ID storage unit 215 stores therein the OCR language ID (final OCR language ID) of the final OCR language selected by the selection unit 211.

The scanning unit 217 is an example of an execution unit that executes functions in accordance with setting information. In the example of FIG. 3, the scanning unit 217 executes the scanning function, and executes the OCR function in the selected final OCR language. The scanning unit 217, for example, controls the scanning engine 231 via a scanning IF 241 that is an example of the APIs on the platform 240 to execute a scanning operation.

Upon receiving a scanning request from a user, the request reception unit 212 transmits the scanning request to the scanning unit 217. The scanning unit 217 controls the scanning engine 231 to execute the scanning function, and to execute the OCR function in the OCR language identified by the final OCR language ID stored in the language ID storage unit 215.

The present embodiment also assumes a case in which a user does not select the final OCR language (does not change the setting that the administrator has set, and scans a document). In this case, for example, the determination unit 220 may read out the default OCR language ID from the default ID storage unit 216 and determine whether the read default OCR language ID is contained in the setting information acquired by the acquisition unit 218. When the default OCR language ID is contained in the acquired setting information, the scanning unit 217 may control the scanning engine 231 to execute a scanning operation in the default OCR language.

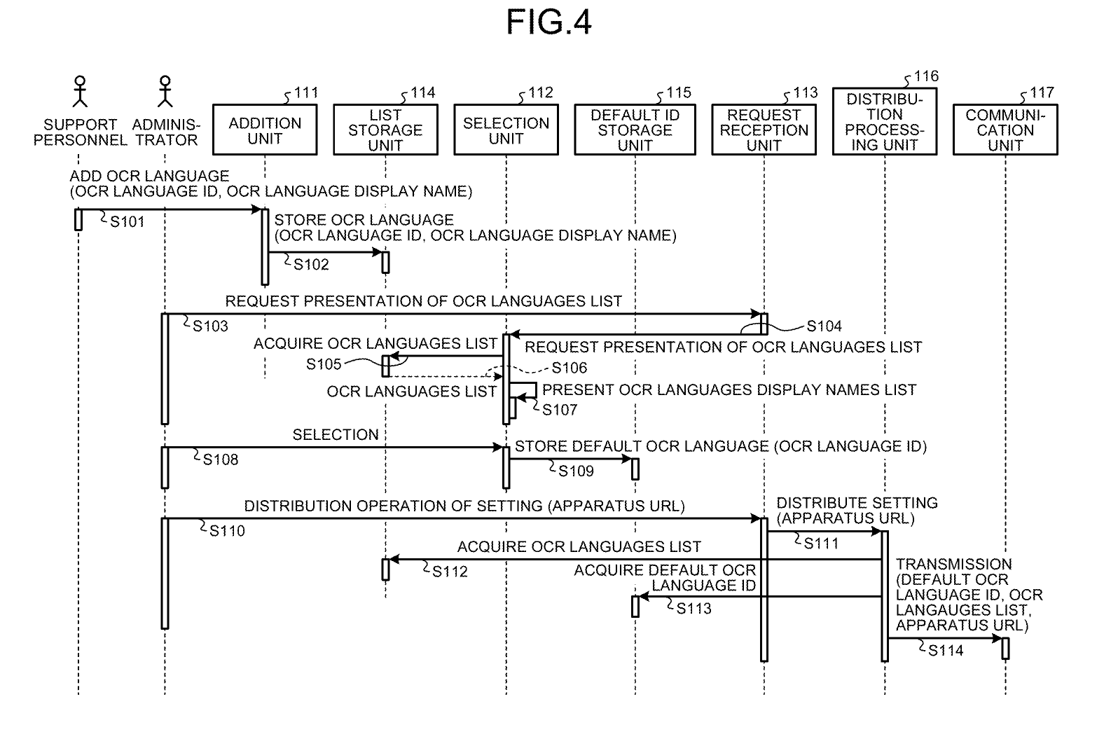

Described next is setting information transmission processing performed by the information processing system according to the present embodiment configured as described above with reference to FIG. 4. FIG. 4 is a sequence diagram illustrating an example of the setting information transmission processing in the present embodiment.

When, for example, a support personnel inputs an additional OCR language, the addition unit 111 receives input information (an OCR language ID and an OCR language display name) (Step S101). The addition unit 111 stores the received setting information in the list storage unit 114 (Step S102).

After Step S102, when, for example, the administrator inputs a request for presenting a list of OCR languages, the request reception unit 113 receives a list presentation request (Step S103). The request reception unit 113 transmits the list presentation request to the selection unit 112 (Step S104). The selection unit 112 acquires an OCR languages list from the list storage unit 114 in accordance with the list presentation request (Step S105, Step S106). The selection unit 112 presents the acquired OCR languages list on, for example, the display unit (Step S107).

When the administrator specifies an OCR language from the OCR languages list displayed on, for example, the display unit in accordance with the list presentation request, the selection unit 112 selects the specified OCR language as the default OCR language (Step S108). The selection unit 112 stores the ID of the selected default OCR language in the default ID storage unit 115 (Step S109).

After Step S109, when, for example, the administrator inputs a request for distributing setting information, the request reception unit 113 receives a distribution request (Step S110). The distribution request may include information (such as an apparatus URL) that specifies, for example, to which MEP 200 the setting information is distributed. The request reception unit 113 specifies an apparatus URL and instructs the distribution processing unit 116 to distribute the setting information (Step S111).

On receiving the distribution instruction, the distribution processing unit 116 acquires the OCR languages list from the list storage unit 114 (Step S112), and acquires the default OCR language ID from the default ID storage unit 115 (Step S113). The distribution processing unit 116 distributes the acquired OCR languages list and the default OCR language ID to the MFP 200 specified by the apparatus URL (Step S114).

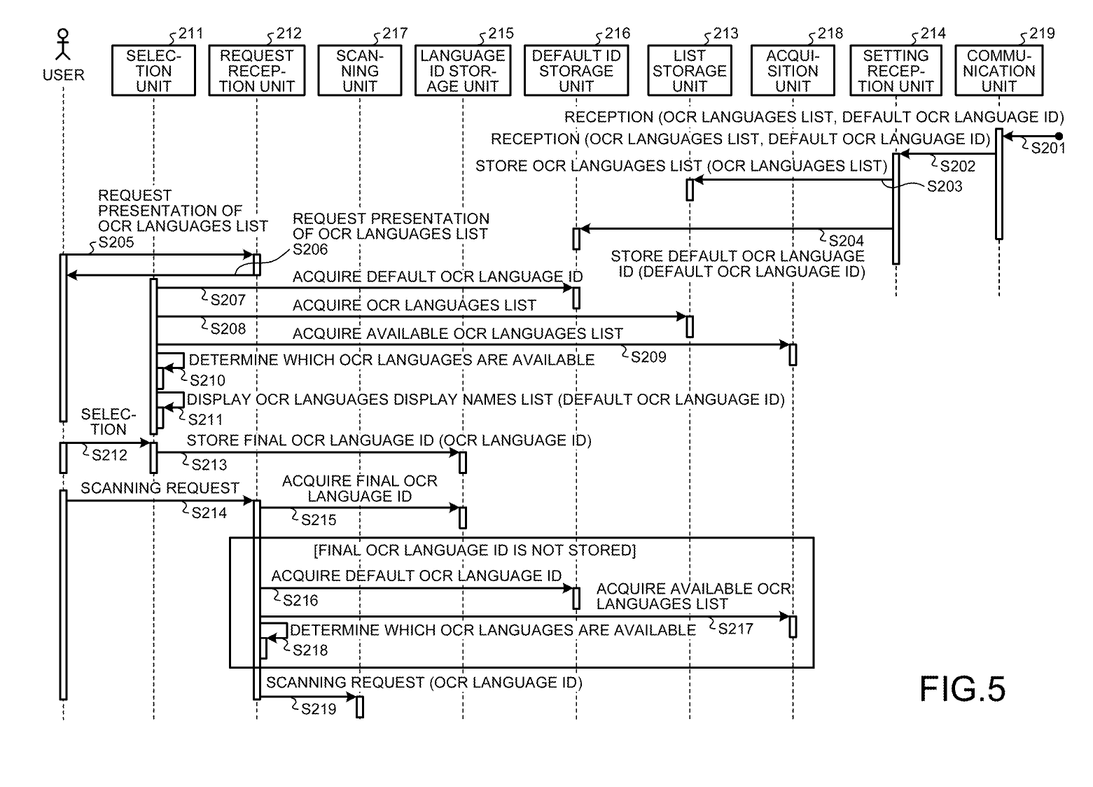

Described next is the scanning processing performed by the information processing system according to the present embodiment configured as described above by using the apparatus application 210 (extended application) with reference to FIG. 5. FIG. 5 is a sequence diagram illustrating an example of the scanning processing in the present embodiment.

The procedure illustrated in FIG. 4 is performed before an actual scanning operation so that the setting information is transmitted from the management tool 110 of the PC 100 to the MFP 200. The communication unit 219 of the MFP 200 (apparatus application 210) receives an OCR languages list and a default OCR language ID from the management tool 110 (Step S201). The setting reception unit 214 receives the received OCR languages list and default OCR language ID (Step S202). The setting reception unit 214 stores the received OCR languages list in the list storage unit 213 (Step S203). The setting reception unit 214 stores the received default OCR language ID in the default ID storage unit 216 (Step S204).

After Step S204, when, for example, a user inputs a request for presenting a list of OCR languages, the request reception unit 212 receives a list presentation request (Step S205). The request reception unit 212 transmits the list presentation request to the selection unit 211 (Step S206). The selection unit 211 acquires the default OCR language ID from the default ID storage unit 216 in accordance with the list presentation request (Step S207). The selection unit 211 acquires the OCR languages list from the list storage unit 213 (Step S208). The selection unit 211 acquires a list of OCR languages that can be set (can be used) in the MFP 200 via the acquisition unit 218 (Step S209).

The selection unit 211 uses the determination unit 220 to determine whether the OCR languages read out from the list storage unit 213 are contained in the OCR languages acquired by the acquisition unit 218 (Step S210). The selection unit 211 uses, for example, the output unit 221 to display a list of display names of the OCR languages contained in the acquired OCR languages on, for example, the display unit (Step S211). The selection unit 211 may specify the default OCR language ID and display an OCR language identified by the default OCR language ID such that a user can find that the OCR language is the default OCR language.

After Step S211, when, for example, a user specifies an OCR language from the displayed list, the selection unit 211 selects the specified OCR language (Step S212). The selection unit 211 stores the OCR language ID of the selected OCR language in the language ID storage unit 215 as the final OCR language ID (Step S213).

After Step S213, when, for example, the user inputs a request for starting a scanning operation, the request reception unit 212 receives a scanning request from the user (Step S214). Upon receiving the scanning request, the request reception unit 212 acquires the final OCR language ID from the language ID storage unit 215 (Step S215).

When the language ID storage unit 215 does not store therein the final OCR language ID, the information processing system performs Step S216 to Step S218 as follows. The request reception unit 212 acquires the default OCR language ID from the default ID storage unit 216 (Step S216). The request reception unit 212 acquires a list of OCR languages available to the MFP 200 via the acquisition unit 218 (Step S217). The request reception unit 212 uses the determination unit 220 to determine whether the OCR language (the default OCR language) identified by the default OCR language ID is contained in the OCR languages acquired by the acquisition unit 218 (Step S218). When the default OCR language is contained in the acquired OCR languages, the user can scan a document in the default OCR language.

The request reception unit 212 specifies the OCR language ID (the final OCR language ID or the default OCR language ID) of the OCR language applied to the scanning operation and transmits a scanning request to the scanning unit 217 (Step S219). After Step S219, the scanning unit 217 performs the scanning operation in the specified OCR language.

As described above, setting information (an OCR language) is added to the information processing system according to the present embodiment from the PC 100 (the management tool 110) and is output such that the administrator or a user can select the added OCR language. This enable the information processing system to properly output setting information corresponding to each function of the electronic apparatus (the MFP 200) even when a new function is added to the electronic apparatus. This enables the administrator or the user to select new setting information (OCR language ID) corresponding to the added function and to use it.

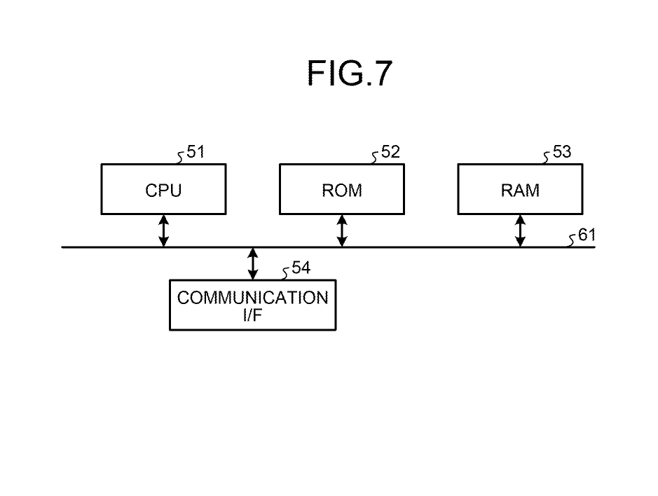

Described next is an example of a hardware configuration of the MFP 200 and the PC 100 according to the present embodiment with reference to FIGS. 6 and 7.

FIG. 6 is a block diagram illustrating a hardware configuration of the MFP 200 according to the present embodiment. As illustrated in FIG. 6, the MFP 200 has a configuration in which a controller 10 is connected to an engine 60 via a peripheral component interface (PCI) bus. The controller 10 controls the overall operation of the MFP 200, and controls graphics, communication, and inputs entered through an operating unit (not illustrated). The engine 60 is, for example, a printer engine that is connectable to the PCI bus. Examples of the engine 60 include a monochrome plotter, a one-drum color plotter, a four-drum color plotter, a scanner, and a facsimile unit. In addition to what is called an engine part such as the plotter, the engine 60 includes an image processing part performing image processing such as error diffusion and gamma conversion.

The controller 10 includes a central processing unit (CPU) 11, a north bridge (NB) 13, a system memory (MEM-P) 12, a south bridge (SB) 14, a local memory (MEM-C) 17, an application specific integrated circuit (ASIC) 16, and a hard disk drive (HDD) 18. The NB 13 and the ASIC 16 are connected via an accelerated graphics port (AGP) bus 15. The MEM-P 12 includes a read only memory (ROM) 12a and a random access memory (RAM) 12b.

The CPU 11 controls the overall operation of the MFP 200 and includes a chipset composed of the NB 13, the MEM-P 12, and the SB 14. The CPU 11 is connected to other devices via the chipset.

The NB 13 is a bridge connecting the CPU 11 with the MEM-P 12, the SB 14 and the AGP bus 15. The NB 13 includes a memory controller that controls reading and writing processing on the MEM-P 12, a PCI master, and an AGP target.

The MEM-P 12 is a system memory that is used as, for example, a storage memory for storing computer programs and data, a loading memory for loading computer programs and data, and a graphics memory of a printer. The MEM-P 12 is composed of the ROM 12a and the RAM 12b. The ROM 12a is a read only memory used as the storage memory for storing computer programs and data. The RAM 12b is a readable and writable memory used as, for example, the loading memory for loading computer programs and data and the graphics memory of a printer.

The SB 14 is a bridge connecting the NB 13 with PCI devices and peripheral devices. The SB 14 is connected to the NB 13 via a PCI bus to which, for example, a network interface (I/F) is also connected.

The ASIC 16 is an integrated circuit (IC) designed for image processing and having a hardware configuration for image processing. The ASIC 16 serves as a bridge that connects the AGP bus 15, the PCI bus, the HDD 18, and the MEM-C 17 to each other. The ASIC 16 includes a PCI target and an AGP master, an arbiter (ARB) that is the core of the ASIC 16, a memory controller that controls the MEM-C 17, a plurality of direct memory access controllers (DMACs) that perform processing such as rotation of image data by, for example, a hardware logic, and a PCI unit that transfers data to the engine 60 via the PCI bus. The ASIC 16 is connected, via the PCI bus, with a facsimile control unit (FCU) 30, a universal serial bus (USB) 40, and the institute of electrical and electronics engineers (IEEE) 1394 interface 50. The operation display unit 20 is directly connected to the ASIC 16.

The MEM-C 17 is a local memory used as a copying image buffer and a code buffer. The HDD 18 is a storage for storing image data, computer programs, font data, and templates.

The AGP bus 15 is a bus interface for a graphics accelerator card designed for increasing the speed of graphics processing. The AGP bus 15 boosts the speed of the graphics accelerator card by directly accessing the MEM-P 12 at a high throughput.

FIG. 7 is a diagram illustrating a hardware configuration of the information processing apparatus (PC 100) according to the present embodiment.

The information processing apparatus according to the present embodiment includes a controller such as a CPU 51, storage devices such as a ROM 52 and a RAM 53, a communication I/F 54 that connects the information processing apparatus to a network to perform communication, an external storage device such as an HDD, or a compact disc (CD) drive, a display device such as a display, input devices such as a keyboard and a mouse, and a bus 61 that connects these devices with each other. The information processing apparatus has a hardware configuration using a normal computer.

The computer programs executed in the apparatuses (the electronic apparatus and the information processing apparatus) according to the embodiment above are recorded and provided, as a computer program product, in a computer-readable recording medium such as a compact disc read only memory (CD-ROM), a flexible disk (FD), a compact disc recordable (CD-R), and a digital versatile disc (DVD), as an installable or executable file.

The computer programs executed in the apparatuses according to the embodiment above may be stored in a computer connected to a network such as the Internet and provided by being downloaded via the network. Furthermore, the computer programs executed in the apparatuses according to the embodiment above may be provided or distributed via a network such as the Internet.

The computer programs executed in the apparatuses according to the embodiment above may be embedded and provided in a ROM, for example.

The computer program executed in the information processing apparatus (PC) according to the embodiment above is configured as a module including the units (the addition unit, the selection unit, the request reception unit, the distribution processing unit, and the communication unit) described above. As an actual hardware configuration, the CPU (processor) reads the computer program from a storage device and executes it to load these units described above on a main memory and generate the units on the main memory.

The computer program executed in the electronic apparatus (MFP) according to the embodiment above is configured as a module including the units (the selection unit, the request reception unit, the setting reception unit, the scanning unit, the acquisition unit, the communication unit, the determination unit, and the output unit) described above. As an actual hardware configuration, the CPU (processor) reads the computer program from the storage device and executes it to load these units described above on the main memory and generate the units on the main memory.

Although the embodiment above describes the OCR function and the languages supported by the OCR function as an example, the function to which the present invention can apply is not limited to the OCR function. In other words, the present invention is applicable to any function as long as the function is a standard function supported by the electronic apparatus and the standard function has different features depending on models of the electronic apparatus.

According to the present invention, when an electronic apparatus having a new function is provided, setting information corresponding to each function of the electronic apparatus can be properly output.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cashe memory of the CPU, and the RAM may function as a physical memory or a primary memory of the apparatus, while the HDD may function as a secondary memory of the apparatus.

What is claimed is:

1. An information processing system comprising:
an information processing apparatus including a first computer program; and
one or more electronic apparatuses including a second computer program,
the first computer program including an addition unit that receives additional setting information on a function executed in the one or more electronic apparatuses and not executed by the second computer program, and a first communication unit that transmits one or more pieces of setting information including the additional setting information to the second computer program included in the one or more electronic apparatuses;
the second computer program including a second communication unit that receives the setting information transmitted from the information processing apparatus, and an output unit that selectively outputs the received setting information.

2. The information processing system according to claim 1, wherein
the second computer program includes:
an acquisition unit that acquires setting information settable on a function supported by the one or more electronic apparatuses;
a determination unit that determines whether the setting information received by the second communication unit is contained in the setting information acquired by the acquisition unit; and
an execution unit that executes a function in accordance with setting information,
the output unit outputs setting information received by the second communication unit and determined to be contained in the setting information acquired by the acquisition unit, and
the execution unit executes a function in accordance with setting information selected from the output setting information.

3. The information processing system according to claim 2, wherein the execution unit executes a function in accordance with setting information set in advance when no setting information is selected.

4. The information processing system according to claim 2, wherein
the setting information includes identification information that identifies a setting and a name of the setting, and
the output unit outputs the name contained in the setting information received by the second communication unit and determined to be contained in the setting information acquired by the acquisition unit.

5. The information processing system according to claim 1, wherein
the first computer program includes a selection unit that selects a piece of setting information from a plurality of pieces of setting information including the additional setting information,
the first communication unit transmits the selected setting information to the one or more electronic apparatuses, and
the second computer program includes
an acquisition unit that acquires setting information settable in the one or more electronic apparatuses;
a determination unit that determines whether the setting information received by the second communication unit is contained in the setting information acquired by the acquisition unit; and
an execution unit that executes, when the setting information received by the second communication unit is determined to be contained in the setting information acquired by the acquisition unit, a function in accordance with the received setting information.

6. An information processing method performed by an information processing system comprising an information processing apparatus including a first computer program and one or more electronic apparatuses including a second computer program, the information processing method comprising:
receiving, by the first computer program, additional setting information on a function executed in the one or more electronic apparatuses and not executed by the second computer program,
transmitting, by the first computer program, one or more pieces of setting information including the additional setting information to the second computer program included in the one or more electronic apparatuses;
receiving, by the second computer program, the setting information transmitted from the information processing apparatus, and
outputting selectively, by the second computer program, the received setting information.

7. The information processing method according to claim 6, further comprising:
acquiring, by the second computer program, setting information settable on a function supported by the one or more electronic apparatuses;
determining, by the second computer program, whether the setting information received at the receiving is contained in the setting information acquired at the acquiring; and
executing, by the second computer program, a function in accordance with setting information, wherein
the outputting includes outputting setting information received at receiving and determined to be contained in the setting information acquired at the acquiring, and
the executing includes executing a function in accordance with setting information selected from the output setting information.

8. The information processing method according to claim 7, wherein the executing includes executing a function in accordance with setting information set in advance when no setting information is selected.

9. The information processing method according to claim 7, wherein the setting information includes identification information that identifies a setting and a name of the setting, and the outputting includes outputs the name contained in the setting information received at the receiving and determined to be contained in the setting information acquired at the acquiring.

10. The information processing method according to claim 6, further comprising:
selecting, by the first computer program, a piece of setting information from a plurality of pieces of setting information including the additional setting information, wherein the transmitting includes transmitting the selected setting information to the one or more electronic apparatuses;
acquiring, by the second computer program, setting information settable in the one or more electronic apparatuses;
determining, by the second computer program, whether the setting information received at the receiving is contained in the setting information acquired at the acquiring; and
executing, by the second computer program, when the setting information received at the receiving is determined to be contained in the setting information acquired at the acquiring, a function in accordance with the received setting information.
